(19) United States
(12) Patent Application Publication
(10) Pub. No.: US 2016/0116392 A1
(43) Pub. Date: Apr. 28, 2016

(54) System and Method for Estimating Remaining Useful Life of a Filter

(71) Applicant: Caterpillar Inc., Peoria, IL (US)

(72) Inventors: Richard Andrew Carpenter, Chillicothe, IL (US); Patrick Opdenbosch, Newnan, GA (US)

(73) Assignee: Caterpillar Inc., Peoria, IL (US)

(21) Appl. No.: 14/523,086

(22) Filed: Oct. 24, 2014

(51) Int. Cl. G01N 15/08; B01D 35/143

(52) U.S. Cl. CPC G01N 15/0826; B01D 35/143

(57) ABSTRACT

A method for estimating a remaining useful life of a filter is provided. The method includes determining, at a processor of a machine, a scaled delta pressure of the filter in the machine based on an input from a plurality of sensors. The method includes determining a plugging parameter of the filter based upon a non-linear relationship between the scaled delta pressure and the plugging parameter of the filter. The method includes estimating the remaining useful life of the filter at a time instant based upon a contamination rate estimate, the contamination rate estimate being determined based upon the determined plugging parameter. The method includes controlling, using a signal, a flow of a fluid entering the filter based on the plugging parameter, and outputting the estimated remaining useful life of the filter on a display.

### TECHNICAL FIELD

This patent disclosure relates generally to filters, and more particularly, to a system and a method for estimating health and remaining useful life of a filter.

### BACKGROUND

Conventionally, fluid filters (e.g., fuel filters, hydraulic filters, etc.) of a machine are replaced based on a predetermined set hours of use and/or a worst-case scenario. The determination of such set hours of use is based on generic filter types and is not specific to the type of filter being considered for replacement. However, different filters have different rates at which they get loaded with particles, and applying a generic conventional scheme to replace the filter based on the hours of use may result foregoing opportunities in operating cost. Further, even for the same filter type, each individual filter has a different loading rate depending upon usage and other environmental factors. Therefore, replacing a filter based upon an hours of usage may not fully utilize the actual operable life of the filter. Some conventional systems provide techniques to predict life of an filter based on a speed and oil temperature to determine a filter pressure differential, and using that pressure differential to calibrate to a linear curve (see, e.g., U.S. Patent Application Publication No. 2003/0226809). However, such linear calibration curves are not accurate.

Accordingly, there is a need to resolve these and other problems related to the conventional filter health and remaining useful life prediction techniques.

### SUMMARY

In one aspect, a method for estimating a remaining useful life of a filter is provided. The method includes determining, at a processor of a machine, a scaled delta pressure of the filter in the machine based on an input from a plurality of sensors. The method includes determining a plugging parameter of the filter based upon a non-linear relationship between the scaled delta pressure and the plugging parameter of the filter. The method includes estimating the remaining useful life of the filter at a time instant based upon a contamination rate estimate, the contamination rate estimate being determined based upon the determined plugging parameter. The method includes controlling, using a signal from the processor to a switch, a flow of a fluid entering the filter based upon the plugging parameter while the machine is used. The method includes and outputting, from the processor, the estimated remaining useful life of the filter on a display while the machine is used.

In another aspect, a system for estimating a remaining useful life of a filter is provided. The system includes an electronic control module coupled to a display. The electronic control module includes a processor and a memory. The processor is operatively coupled to a plurality of sensors. The processor is configured to determine a scaled delta pressure of the filter based on an input from the plurality of sensors, determine a plugging parameter of the filter based upon a non-linear relationship between the scaled delta pressure and the plugging parameter of the filter, estimate the remaining useful life of the filter at a time instant based upon a contamination rate estimate, the contamination rate estimate being determined based upon the determined plugging parameter, and output the remaining useful life of the filter on the display while the filter is being used.

In yet another aspect, a non-transitory computer readable medium storing computer executable instructions thereupon for estimating a remaining useful life of a filter is provided. The instructions when executed by a processor of an electronic control module of a machine cause the processor to determine a scaled delta pressure of the filter based on an input from a plurality of sensors, determine a plugging parameter of the filter based upon a non-linear relationship between the scaled delta pressure and the plugging parameter of the filter, estimate the remaining useful life of the filter at a time instant based upon a contamination rate estimate, the contamination rate estimate being determined based upon the determined plugging parameter, control, using a signal from the processor to a switch, a flow of a fluid entering the filter based on the plugging parameter while the machine is used, and output the remaining useful life of the filter on a display coupled to the electronic control module.

### BRIEF DESCRIPTION OF THE DRAWINGS

FIG. 1 illustrates a machine including a system for estimating health and remaining useful life of a filter, in accordance with an aspect of this disclosure.

FIG. 2 illustrates a method for estimating health and remaining useful life of a filter using a flow diagram, in accordance with an aspect of this disclosure.

FIG. 3 illustrates filter maps for a filter in the machine of FIG. 1, in accordance with an aspect of this disclosure.

FIG. 4 illustrates a plot for a non-linear estimate of a delta pressure across the filter, in accordance with an aspect of this disclosure.

FIG. 5 illustrates a plot for a health estimate of the filter, in accordance with an aspect of this disclosure.

FIG. 6 illustrates a plot for a delta pressure across the filter, in accordance with an aspect of this disclosure.

FIG. 7 illustrates plots indicating a health of the filter with respect to a threshold range, in accordance with an aspect of this disclosure.

FIG. 8 illustrates a plot for a contamination rate update request, in accordance with an aspect of this disclosure.

FIG. 9 illustrates a plot for a contamination rate estimate, in accordance with an aspect of this disclosure.

FIG. 10 illustrates a plot for a remaining useful life estimate of the filter, in accordance with an aspect of this disclosure.

### DETAILED DESCRIPTION

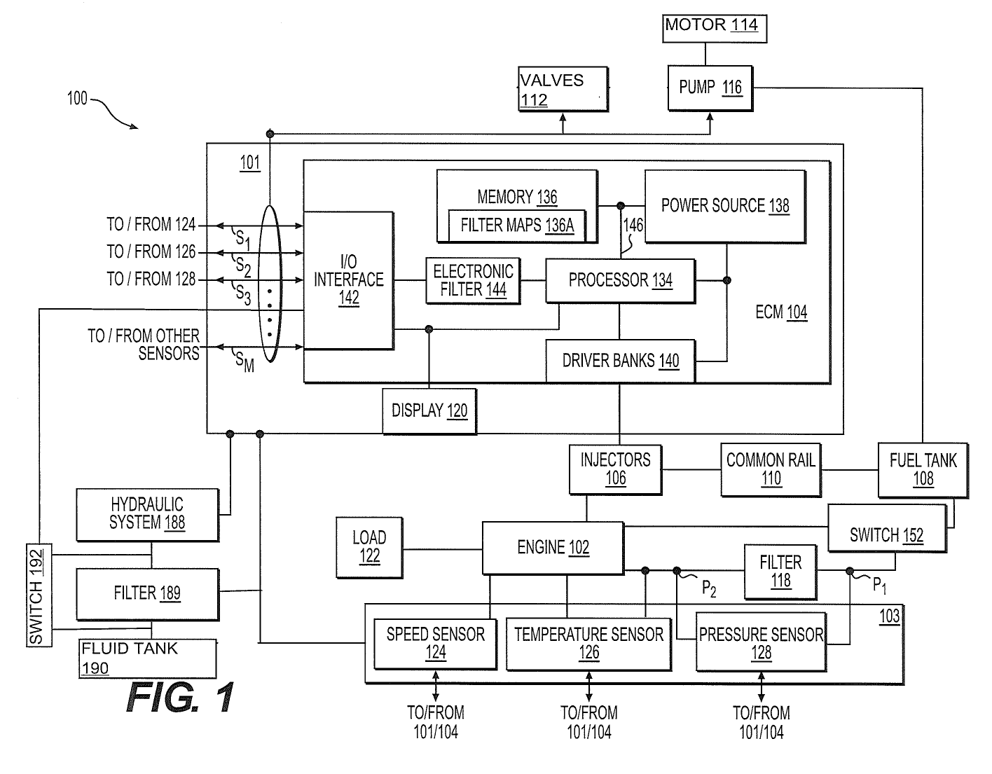

Now referring to the drawings, wherein like reference numbers refer to like elements, there is illustrated in FIG. 1, a machine 100, by way of a schematic block diagram. It will be appreciated that the specific positioning and arrangement of various components of the machine 100 in FIG. 1 is by way of example only and not by way of limitation, as other positions and arrangements may exist. The machine 100 may be a mobile or a stationary machine that performs operations associated with industries such as mining, construction, fanning, transportation, landscaping, oil industry, manufacturing, or the like. For example, the machine 100 may be a track type tractor or dozer, a motor grader, a drilling station, a car, a truck, a bus, or other types of stationary or mobile machines. In one aspect, the machine 100 may be operating on a worksite and is in communication with a base station and a global navigation satellite system (GNSS) for operation. While the following detailed description describes an exemplary aspect in connection with the machine 100, it should be appreciated that the description applies equally to the use of the present disclosure in various types of machines.

The machine 100 may include an engine 102, an electronic control module (ECM) 104, a plurality of injectors 106, a fuel tank 108, a common rail 110, valves 112, a motor 114, a pump 116, a filter 118, a hydraulic system 188, a filter 189 of the hydraulic system 188, a fluid tank 190 of the hydraulic system 188, and a display 120. Additionally or optionally, the machine 100 may include or may be coupled to a load 122. In one aspect of this disclosure, the machine 100 may include a plurality of sensors 103 including a speed sensor 124, a temperature sensor 126, and a pressure sensor 128. The speed sensor 124 and the temperature sensor 126 may be coupled to the engine 102 and to the ECM 104, and the pressure sensor 128 may be coupled to the filter 118 and/or to the filter 189 of the hydraulic system 188. Alternatively or additionally, the hydraulic system 188 and the filter 189 of the hydraulic system 188 may have their own sets of sensors (not shown) similar to the speed sensor 124, the temperature sensor 126 and the pressure sensor 128. The term “filter” as used herein relates to both the filter 118 and the filter 189 of the hydraulic system 188. However, the term “filter” may be used for various types of filters used in the machine 100, and the discussion herein with respect to the filter 118 and the filter 189 is not meant to be limiting. Generally, various aspects of the disclosure relate to various types of filters in the machine 100 across which a pressure drop or pressure difference or delta pressure, among other parameters, may be measured, for example, using pressure sensors similar to the pressure sensor 128. Further, the ECM 104 may be operatively coupled to all such filters and their respective sensors or sensor modules. Furthermore, it will be appreciated that the machine 100 may include other components, including but not limited to, vehicular parts including tires, wheels, engagement mechanisms, transmission, steering system, additional sensor modules, additional motors, on-board communication systems, catalytic converters, axles, crankshafts, camshafts, gear systems, clutch systems, batteries, throttles, actuators, suspension systems, cooling systems, exhaust systems, chassis, ground engaging tools, imaging systems, power trains, and the like (not shown). It will be appreciated that lines connecting various components of the machine 100 are not limiting in terms of the connections, positioning, and arrangements of the components of the machine are concerned. Rather, these lines in FIG. 1 are for illustrative purposes and other lines or other arrangements, positions, and couplings of the components of the machine 100 may exist.

The engine 102 may be a large gas engine, a diesel engine, a dual fuel engine (natural gas-liquid fuel mixture), an electric/battery powered motor, a hybrid electric-natural gas-fossil fuel engine, combinations thereof or any other type of large. engine. In one aspect, the engine 102 is a hybrid engine in which a plurality of energy sources may be used. Such usage may occur separately or at the same time for the different types of fuels. The engine 102 may be coupled at its input to the plurality of injectors 106 and, at an output, to the load 122. The engine 102 may also be coupled to the fuel tank 108. In one aspect, the engine 102 may be an in-line six cylinder engine, although it is understood that the aspects of the present disclosure are equally applicable to other types of engines such as V-type engines and rotary engines, and that the engine 102 may contain any number of cylinders or combustion chambers.

The ECM 104 is a programmable electronic device that may be coupled to the engine 102 (via the injectors 106), the speed sensor 124, the temperature sensor 126, the pressure sensor 128, the hydraulic system 188, the filter 189 of the hydraulic system 188, in addition to other filters, sensor modules, fuel systems, and actuator systems of the machine 100. In one aspect, the ECM 104 is coupled to and is configured to probe and receive a response from the speed sensor 124, the temperature sensor 126, and the pressure sensor 128 to determine a health and a remaining useful life (RUL) of the filter 118 and/or the filter 189 of the hydraulic system 188. In another aspect, the ECM 104 may have a protective cover to provide protection from temperature variations and external electromagnetic fields. In various implementations of the disclosure, only one ECM 104 may be provided to implement the various features and functionalities of the disclosure. Alternatively, more than one ECM similar to the ECM 104 could be provided inside or on the machine 100.

The ECM 104 may include a processor 134, a memory 136, a power source 138, a plurality of driver banks 140, an input/output (I/O) interface 142, an electronic filter 144, and a bus 146 coupling various components of the ECM 104. Although not explicitly shown in the several figures of this disclosure, it will be appreciated that the ECM 104 may include other components such as heat sinks, a governor such as a proportional integral derivative (PID) controller for regulating speed of the engine 102, signal converters and voltage converters, analog to digital converters (ADCs) and digital to analog converters (DACs), amplifiers, electronic filters, backup processors and/or co-processors, and circuitry including power supply circuitry, signal conditioning circuitry, solenoid driver circuitry, analog circuits, communication chips (e.g., CAN chips, GPS/GNSS chips, etc.), phase locked loops (PLLs), graphics controllers, and/or programmable logic arrays or other application specific integrated circuits (ASICs). These components of the ECM 104 may be included on a single layer or a multi-layer printed circuit board (PCB).

In one aspect, the processor 134 of the ECM 104 may be an n-bit microprocessor, where ‘n’ is an integer (e.g., n=16, 32, etc.) operating at a particular clock frequency (e.g., 40 MHz). The processor 134 is coupled to the memory 136, the electronic filter 144, the power source 138, the plurality of driver banks 140, and the I/O interface 142. Generally, based upon sensor data received at the I/O interface 142 from the speed sensor 124, the temperature sensor 126, the pressure sensor 128 and/or other sensor modules and actuator systems of the machine 100, the processor 134 is configured to determine the health and the remaining useful life of the filter 118 and/or the filter 189 of the hydraulic system 188. Data obtained from the speed sensor 124, the temperature sensor 126, the pressure sensor 128 and/or other sensor modules and actuator systems of the machine 100 on a plurality of input/output signal lines S₁-Sₘ (‘m’ being an integer) may correspond to one or more sensor inputs such as oil temperature and pressure for various oil circulation systems (including the hydraulic system 188) of the machine 100, operating conditions of the engine 102 including engine speed, engine temperature, pressure of the actuation fluid, cylinder piston position, pressure drop across the filter 118 and/or the filter 189, etc. For example, the processor 134 may be used to determine the health and/or remaining useful life of the filter 118 and/or the filter 189 and predict or estimate a remaining useful life of the filter 118 and/or the filter 189 based upon the data obtained from the plurality of sensors 103 on the plurality of input/output signal lines S₁-Sₘ of the ECM 104. In one aspect, the processor 134 may execute computer executable instructions residing or stored on a non-transitory computer readable medium (e.g., the memory 136) to estimate the health and the remaining useful life of the filter 118 and/or the filter 189. The instructions when executed by the processor 134 of the ECM 104 of the machine 100 cause the processor 134 to carry out various features and functionalities of the aspects of this disclosure discussed herein. For example, the processor 134 is further configured to control the display 120, although the processor 134 may control other output devices (not shown) instead of or in addition to the display 120. The display 120 may be configured, for example, to display a continuous estimate of the health and the remaining useful life of the filter 118 and/or the filter 189 for identifying when the filter 118 and/or the filter 189 was newly installed in the machine 100 and when the filter 118 and/or the filter 189 needs replacement. Based on the displayed data on the display 120, a technician may plan the logistics associated with the upkeep and replacement of the filter 118. In one aspect, the processor 134 is a non-generic hardware processor configured to improve the functioning of a system 101 by solving the complex problem of accurately predicting when the filter 118 and/or the filter 189 in the machine 100 needs to be changed or replaced, and how much remaining useful life of the filter 118 and/or the filter 189 remains.

The memory 136 is connected to or coupled to the processor 134 by the bus 146. The memory 136 may store computer readable and computer executable instruction sets. In one aspect, the memory 136 stores a plurality of filter maps 136a, fuel maps, lookup tables, variables, and the like associated with the machine 100. In one aspect, the memory 136 may be an electrically erasable programmable read-only memory (EEPROM), although other memory types could be used (e.g., random access memory (RAM) units). In one aspect, the memory 136 includes computer executable instructions thereupon, which when executed by the processor 134 cause the processor to determine the health of the filter 118 and predict a remaining useful life of the filter 118, in accordance with the various aspects of the present disclosure.

The plurality of filter maps 136a include data related to parameters associated with a new oil filter or a new hydraulic fluid filter similar to the filter 118 and the filter 189, respectively, as well as data related to parameters associated with the filter 118 and/or the filter 189. Such data may include, but are not limited to, bypass pressure settings, plugged filter mapping, a contamination or a loading profile, various standardized data related to the filter 118 and/or the filter 189 (e.g., International Standardization Organization (ISO) data), field test data of the filter 118 and/or the filter 189, and field test data of a new filter at various temperature, engine speed and delta pressure values. The term “contamination” as used herein relates to a loading of the filter 118 and/or the filter 189 with fluid particles (e.g., fuel particles and/or hydraulic fluid particles, or other types of particles). In one aspect of this disclosure, the plurality of filter maps 136a may be arranged to be displayed on the display 120, for example, upon commands received from the processor 134. By way of example only and not by way of limitation, the memory 136 may store the plurality of filter maps 136a as a lookup table (LUT), although other standard storage techniques (matrices, linked lists, tress, etc.) could be used. In one aspect, the memory 136 may be configured to store data from field tests carried out on the filter 118 and/or the filter 189 in the plurality of filter maps 136a. Such data may be used to generate and/or store one or more models simulating the contamination profile of the filter 118 and/or the filter 189. Further, different types of the plurality of filter maps 136a may exist in the memory 136 for different types of filters (e.g., based on vendor type, functionality, size, filter resolution, etc.).

The electronic filter 144 may be a low pass electronic filter configured to remove or limit noise in the data signals received at the I/O interface 142. In one aspect, the electronic filter 144 may be implemented as part of the processor 134 using integrated, discrete, or mixed type components. The electronic filter 144 may be based upon Butterworth, Chebyshev or other types of polynomials. In another aspect, the electronic filter 144 may be couple to a digital signal processor (DSP) (not shown) and may be a digital electronic filter. In yet another aspect, the electronic filter 144 may be an analog filter coupled to an analog to digital converter (ADC) and to a limiting circuit (not shown). The electronic filter 144 is not to be confused with and is distinguished from the various mechanical fluid filters (e.g., the filter 118 and the filter 189) in the machine 100, referred to herein.

The plurality of driver banks 140 may be electro-mechanical actuators configured to trigger or control the plurality of injectors 106. The plurality of driver banks 140 may be powered by the power source 138. The power source 138 may be a battery that may be configured to power various components of the ECM 104 including but not limited to the plurality of driver banks 140, the processor 134, and the memory 136.

The display 120 may generally be an output device configured to output real-time data related to the health and the remaining useful life of the filter 118 as and when electrical signals form the plurality of sensors 103 are received and processed by the processor 134 of the ECM 104. For example, the display 120 may be a display unit inside an operator cab of the machine 100. Alternatively, the display 120 may be an output device provided at other locations on the machine 100. In one aspect, the display 120 may be in a remote location away from the machine 100. The display 120 may then display data wirelessly communicated from the ECM 104 via one or more antennas (not shown) on the machine 100 to a remote base station (not shown). Such a scenario may exist, for example, in hazardous environments where the machine 100 may be operated remotely in an unmanned mode. In one aspect, the display 120 may be a liquid crystal display, although other types of display may be used. In another aspect of this disclosure, the display 120 may be a light emitting diode (LED) based indicator configured to indicate a health and remaining useful life of the filter 118 and/or the filter 189, among other parameters. The display 120 may, for example, communicate with the processor 134 and/or a graphics processor inside the ECM 104 to provide a display, in real-time, regarding various variables associated with the machine 100 while the machine 100 is being used, in addition to the parameters of the filter 118 and/or the filter 189. For example, as discussed, the display 120 may provide visual indications of real time or instantaneous speed and temperature of the engine 102, pressure drop or delta pressure across the filter 118 and/or the filter 189, a health estimate of the filter 118 and/or the filter 189, and a remaining useful life (RUL) of the filter 118 and/or the filter 189, during usage of the machine 100.

In one aspect of this disclosure, the ECM 104 including the processor 134 and the memory 136 are operatively coupled to the plurality of sensors 103 to form the system 101 for estimating a remaining useful life of the filter 118 and/or the filter 189. The system 101 may include additional components such as additional sensors, processors, ECMs, memory units, communication devices, antennas, and the like. The system 101 may be part of the machine 100 and included within the machine 100. Alternatively, one or more components of the system 101 may be outside or remote from the machine 100.

In one aspect of this disclosure, the speed sensor 124 may be a tachometer configured to measure an instantaneous speed of the engine 102, although other types of speed sensors could be used. The speed sensor 124 may be coupled to the ECM 104 to communicate speed information (e.g., in rotations per minute (rpm)) to the processor 134 via the I/O interface 142. Likewise, the temperature sensor 126 may be a thermometer device coupled to the ECM 104 to communicate temperature information (e.g., in ° C./° F.) to the processor 134 via the I/O interface 142. The pressure sensor 128 may be coupled to the ECM 104 to communicate delta pressure or pressure drop across the filter 118 and/or the filter 189 (e.g., in kPa) to the processor 134 via the I/O interface 142. By way of example only, the pressure sensor 128 may be a dual absolute pressure sensor. It will be appreciated that the positions of the speed sensor 124, the temperature sensor 126 and the pressure sensor 128 are shown by way of example only and not by way of limitation as these other positions may exist. For example, the speed sensor 124, the temperature sensor 126 and the pressure sensor 128 may be coupled to the hydraulic system 188 and the filter 189 in a manner similar to that shown for the engine 102 and the filter 118. Further, the speed sensor 124, the temperature sensor 126 and the pressure sensor 128 are not the only sensors inside the machine 100 and other sensors or sensor modules may be present to detect various parameters associated with the machine 100. In addition to or optionally, the plurality of sensors 103 may communicate various measurements of the machine 100 as electrical or wireless signals to a remote base station (not shown) for analysis and control, e.g., via a GNSS system (not shown) coupled to the machine 100. Furthermore, the speed sensor 124, the temperature sensor 126 and the pressure sensor 128 may be coupled to other parts of the machine 100 to measure speed, temperature and pressure or pressure drop of those parts.

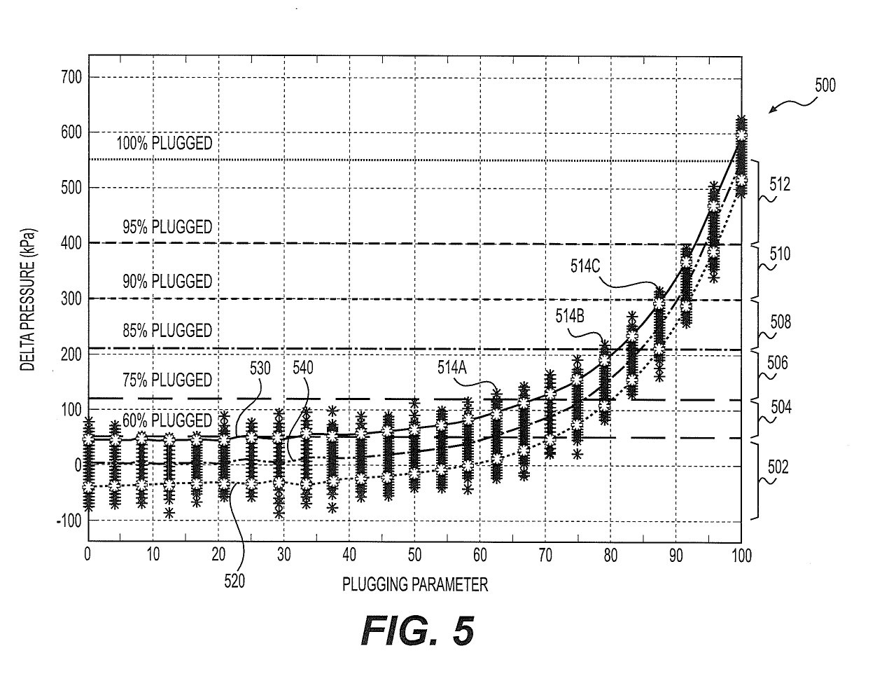

The filter 118 may be part of a fuel system of the machine 100. Likewise, the filter 189 may be part of the hydraulic system 188 or an oil circulation system (not shown) of the machine 100. Generally, in various aspects of this disclosure, the term “filter” may refer to a fluid filter such as the filter 118 and/or the filter 189, and may be used, for example, for a hydraulic oil filter, a transmission oil filter, and/or an engine oil filter. As illustrated in FIG. 1, the filter 118 may be provided at an output of the fuel tank 108, although the filter 118 may be provided coupled to an oil tank for other systems such as powertrain, and/or transmission systems of the machine 100. Similarly, the filter 189 is illustrated coupled to the hydraulic system 188 but may be provided coupled to an output of the fluid tank 190 and may be further coupled to different parts of an oil circulation system and/or an oil lubrication system of the machine 100. Further, though FIG. 1 illustrates only one of the filter 118 and the filter 189, each of the filter 118 and the filter 189 may include a plurality of filters or a filter bank. When the filter 118 and/or the filter 189 are newly installed, the pressure drop between an input and an output terminal of the filter 118 and/or the filter 189 is at a minimum (or, low). As the filter 118 and/or the filter 189 are used, the filter 118 and/or the filter 189 is plugged/loaded with trapped particles, e.g., fuel particles from the fuel provided from the fuel tank 108 (for the filter 118) or from the hydraulic fluid particles (for the filter 189) of the hydraulic system 188. Due to such loading, a health of the filter 118 and/or the filter 189 deteriorates and it is useful to know or at least estimate the remaining useful life (RUL) of the filter 118 and/or the filter 189. Such knowledge of the RUL of the filter 118 and/or the filter 189 may be used in a determination of when the filter 118 and/or the filter 189 should be replaced or bypassed. For example, when the filter 118 is highly loaded with particles (e.g., 75%, 90%, or even 100%), the system 101 may not be able to drive sufficient fuel flow to the engine 102. As a result, the engine 102 may stall or malfunction. In such a scenario, a switch 152 may control and/or prevent fluid from entering the filter 118 based upon a signal received from the processor 134. The switch 152 may provide an indication to an operator of the machine 100 that the filter 118 is plugged. By way of example only, the switch 152 may be a delta pressure switch, although other types of switches could be used. The engine 102 may then be shut down or de-rated instead of allowing dirty fuel to enter the plurality of injectors 106. The filter 118 may then be accordingly replaced. Therefore, based upon how loaded the filter 118 may be (as measured, for example, by a plugging parameter (ε)), the processor 134 may send a signal to the switch 152 and/or a switch 192 to the filter 118 and the fluid entering the filter 118 and/or the filter 189, respectively, may be controlled and/or prevented from entering the filter 189 when the plugging parameter falls within a threshold range in a plurality of threshold ranges 502, 504, 506, 508, 510, and 512 shown in a plot 500 in FIG. 5.

Likewise, when the filter 189 is highly loaded (e.g., 75%, 90%, or even 100%) with hydraulic fluid particles, the flow of the hydraulic fluid to the filter 189 may be controlled by bypassing the filter using the switch 192 based on a signal from the processor 134 to the switch 192. Therefore, based upon how loaded the filter 189 may be (as measured, for example, by the plugging parameter (ε)), the processor 134 may send a signal to the filter 189 and fluid may be controlled and/or prevented from entering the filter 189 when the plugging parameter falls within or above a threshold range in the plurality of threshold ranges 502, 504, 506, 508, 510, and 512 shown in a plot 500 in FIG. 5. The hydraulic fluid (e.g., lubrication oil) may then be directly provided to the hydraulic system 188 from the fluid tank 190 in the machine 100. The filter 189 may then be replaced. By way of example only, the switch 192 may be a valve, a cutoff switch, or other types of mechanical/electro-mechanical switches operatively coupled to and controllable by the processor 134.

As discussed, the filter 118 and/or the filter 189 may not be the only fuel and hydraulic fluid filters in the machine 100. For example, other fluid filters may filter hydraulic or power train fluids and pressure sensors across each such additional filter may communicate the delta pressure for each of the filters to the ECM 104. By way of example only, the filter 118 and/or the filter 189 may be one of the various oil filters manufactured by Caterpillar Inc. of Peoria, Ill. The processor 134 may provide the health estimate and the remaining useful life of the filter 118 and/or the filter 189 based upon the specific type of the filter 118 and/or the filter 189, respectively. For example, the plurality of filter maps 136a may include filter maps specific to the type of the filter 118 and/or the filter 189. These specific filter maps 136a may be provided to the processor 134 to determine out the health estimate and the remaining useful life of the filter 118 and/or the filter 189 based upon the specific type of the filter 118 and/or the filter 189.

### INDUSTRIAL APPLICABILITY

Various aspects of the present disclosure are applicable generally to filters of the machine 100. More particularly, various aspects of the present disclosure are applicable to the system 101 and a method 200 for estimating the health and remaining useful life of the filter 118 and/or the filter 189 of the machine 100.

Conventionally, filters in various machines are replaced based on an arbitrarily set hours of use. The determination of such set hours of use is based on generic filter types and is not specific to the type of filter being considered for replacement. In reality, different filters have different contamination rates and applying a generic conventional scheme to replace a particular type of filter based on prefixed hours of use may result in wasteful use, increasing overhead and operational costs. Further, even for the same filter type, each individual filter has a different contamination rate depending upon usage and other environmental factors. Simply replacing a filter based upon an hours of usage metric may not fully utilize the actual operable life of the filter.

According to an aspect of this disclosure, an exemplary solution to the problems in conventional systems and methods is to provide a better technique based on a more accurate model of the contamination of the filter 118 and/or the filter 189 and using the data obtained from one or more of the plurality of sensors 103 (e.g., the pressure sensor 128) in the model to better predict and improve an estimate of the remaining useful life of the filter 118 and/or the filter 189 in real-time as the filter 118 and/or the filter 189 is being used by the machine 100 during operation of the machine 100. It will be appreciated that the various aspects of this disclosure relating to the filter 118 are equally applicable to the filter 189 of the hydraulic system 188, and vice-versa.

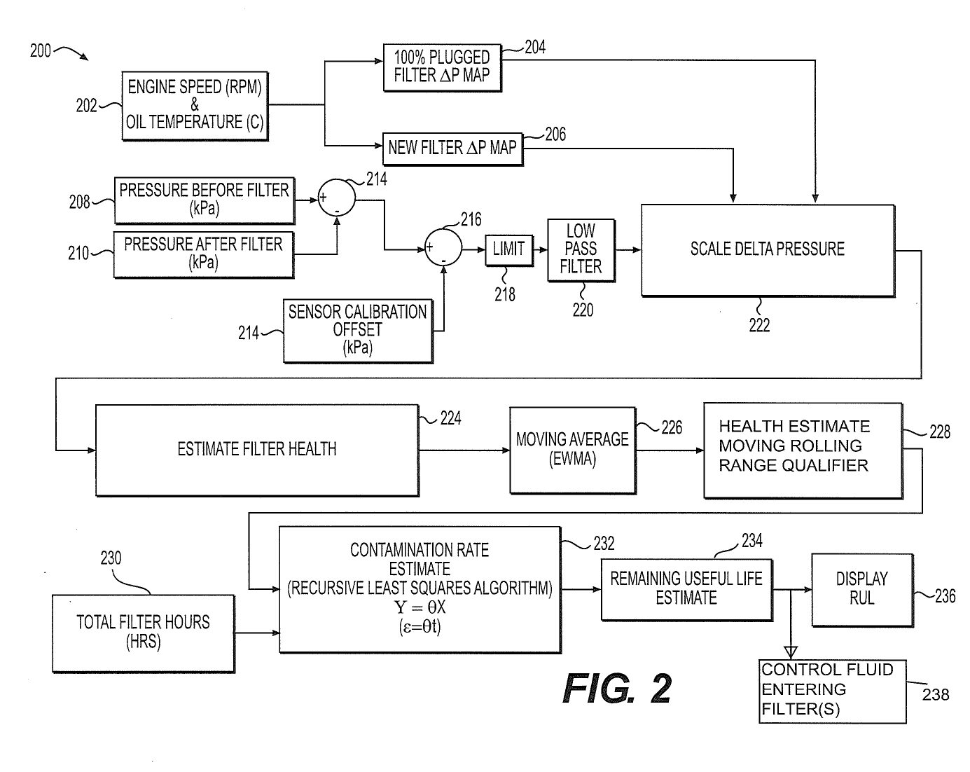

Referring to FIG. 2, the method 200 for estimating the remaining useful life (RUL) of the filter 118 and/or the filter 189 is illustrated, in accordance with an aspect of this disclosure. FIG. 2 presents the method 200 as a flow diagram, although the method 200 may be understood using other types of presentations such as process diagrams, graphs, flowcharts, equations, etc. In one aspect, one or more processes or operations in the method 200 may be carried out by the ECM 104 inside the machine 100. For example, the one or more processes or operations may be carried out by the processor 134 inside the ECM 104, using the data received from the plurality of sensors 103 and the plurality of filter maps 136a and executing computer executable instructions stored in the memory 136 of the ECM 104. As discussed, the data from the plurality of sensors 103 may be received at the ECM 104 and processed by the processor 134 while the machine 100 is in use or is in operation in a work environment. In another aspect, in the method 200, one or more processes or operations, or sub-processes thereof, may be skipped or combined as a single process or operation, and the flow of processes or operations in the method 200 may be in any order not limited by the specific order illustrated in FIG. 2. For example, one or more processes or operations may be moved around in terms of their respective orders, or may be carried out in parallel.

The method 200 may begin in an operation 202 where an engine speed of the engine 102 and an oil temperature are received at the ECM 104. The engine speed may be obtained by the speed sensor 124 (e.g., in rpm) and communicated to the I/O interface 142. Likewise, the oil temperature may be obtained by the temperature sensor 126 (e.g., in ° C./° F.) and communicated to the I/O interface 142. The engine speed and the oil temperature may be obtained as a continuous time series as the machine 100 is in operation or use, and instantaneous values may be stored in the memory 136 based upon a sampling rate at which the speed sensor 124 and the temperature sensor 126 are probed by the ECM 104 to obtain the data. In one aspect, the data obtained at the I/O interface 142 may be processed by the processor 134. For example, the data may be conditioned, digitized, filtered, etc., and stored in the memory 136 by the processor 134. Alternatively, the I/O interface 142 may include signal-processing circuitry to provide the data from the plurality of sensors 103 in a digital format to the processor 134 for carrying out various calculations.

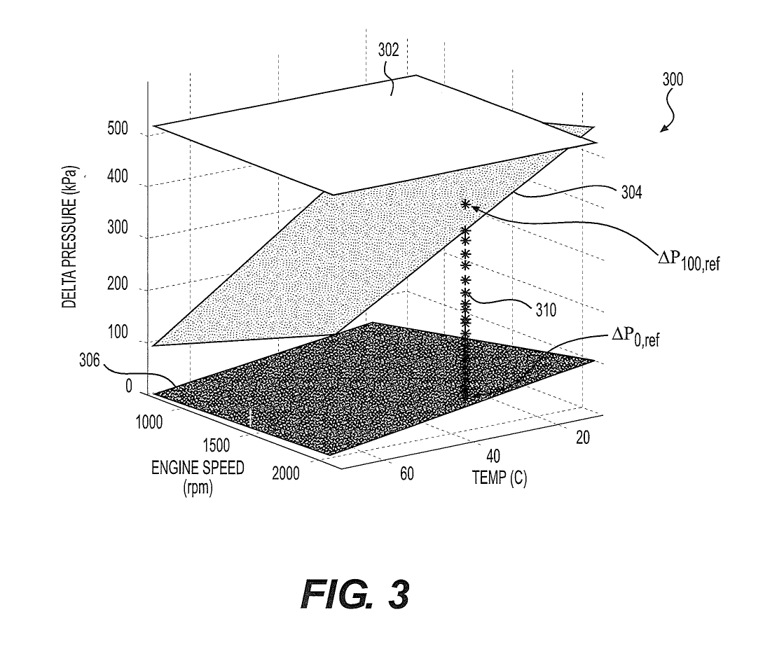

In an operation 204, the processor 134 may obtain a first delta pressure map 302 (shown in a plot 300 in FIG. 3) from the plurality of filter maps 136a associated with a fully plugged (or, 100% plugged) filter 118 and/or the filter 189. The first delta pressure map 302 may be stored in the memory 136. In one aspect, the first delta pressure map 302 may be stored as a look-up table in the memory 136, though other types of storage techniques for the first delta pressure map 302 could be used (e.g., linear arrays, linked lists, etc.). The first delta pressure map 302 provides the processor 134 data regarding a pressure drop or delta pressure (e.g., in kPa) with respect to the engine speed (e.g., in rpm) and the oil temperature (e.g., in ° C.). By way of example only and not by way of limitation, the first delta pressure map 302 may provide delta pressure in a range of over 500 kPa for the engine speed data range from 0-3000 rpm and the oil temperature ranging from 0-100° C., as illustrated in FIG. 3. Using the first delta pressure map 302, the processor 134 determines what the delta pressure across the filter 118 and/or the filter 189 should be at a given engine speed and oil temperature (e.g., the engine speed and the oil temperature values received in the operation 202), if the filter 118 and/or the filter 189 were completely plugged (100% plugged). A value of the delta pressure at 100% plugging of the filter 118 and/or the filter 189 for the engine speed and the oil temperature obtained in the operation 202 may be stored by the processor 134 in the memory 136 as a variable or an array denoted by ΔP₁₀₀. By way of example only, the plot 300 is shown in a logarithmic scale, though other types of scales may be used.

Likewise, in an operation 206, the processor 134 may obtain a second delta pressure map 306 (shown in FIG. 3) from the plurality of filter maps 136a for when the filter 118 and/or the filter 189 is/was new (or, 0% plugged). The second delta pressure map 306 may be stored in the memory 136. In one aspect, the second delta pressure map 306 may be stored as a look-up table in the memory 136, though other types of storage techniques for the second delta pressure map 306 could be used (e.g., linear arrays, linked lists, etc.). The second delta pressure map 306 provides the processor 134 data regarding a pressure drop or delta pressure (e.g., in kPa) with respect to the engine speed (e.g., in rpm) and the oil temperature (e.g., in ° C.). By way of example only and not by way of limitation, the second delta pressure map 306 may provide delta pressure in a range of over 500 kPa for the engine speed data range from 0-3000 rpm and the oil temperature ranging from 0-100° C., as illustrated in FIG. 3. Using the second delta pressure map 306, the processor 134 determines what the delta pressure across the filter 118 and/or the filter 189 should be at a given engine speed and oil temperature (e.g., the engine speed and the oil temperature values received in the operation 202), if the filter 118 and/or the filter 189 were new with no contamination or plugging (0% plugged). The second delta pressure map 306 may be derived to fit field test data for various engine speeds and temperatures with respect to pressure drop across the filter 118 and/or the filter 189, prior to the machine 100 being put to use. In one aspect, the first delta pressure map 302 and the second delta pressure map 306 may be specific to a type of the filter 118 and/or the filter 189. For example, the processor 134 may obtain the type of the filter 118 and/or the filter 189 from the memory 136 and accordingly obtain the first delta pressure map 302 and the second delta pressure map 306 for the specific type of the filter 118 and/or the filter 189. A value of the delta pressure at 0% plugging of the filter 118 and/or the filter 189 for the engine speed and the oil temperature obtained in the operation 202 may be stored by the processor 134 in the memory 136 as a variable or an array denoted by ΔP₀.

In an operation 208, the processor 134 may obtain, at the I/O interface 142 of the ECM 104, a first pressure (P₁) before the filter 118 (or, at an input of the filter 118) from the pressure sensor 128. The first pressure P₁ before the filter 118 may be provided to the ECM 104 at one of the plurality of input/output signal lines S₁-Sₘ (e.g., in KPa). Likewise, the processor 134 may obtain a pressure value before the filter 189 from a pressure sensor (not shown) similar to the pressure sensor 128 coupled to the filter 189. Alternatively, the pressure sensor 128 may be coupled to both the filter 118 and the filter 189 to provide respective pressure values at the inputs of the filter 118 and the filter 189 to the processor 134.

In an operation 210, the processor 134 may obtain, at the I/O interface 142 of the ECM 104, a second pressure P₂ after the filter 118 (or, at an output of the filter 118) from the pressure sensor 128. The second pressure after the filter 118 may be provided to the ECM 104 at one of the plurality of input/output signal lines S₁-Sₘ (e.g., in KPa). Likewise, the processor 134 may obtain a pressure value after the filter 189 from the pressure sensor coupled to the filter 189. Alternatively, the pressure sensor 128 may be coupled to both the filter 118 and the filter 189 to provide respective pressure values at the outputs of the filter 118 and the filter 189 to the processor 134.

In an operation 212, the processor 134 may calculate a difference of the pressure before the filter 118 and/or the filter 189 (from the operation 208) and the pressure after the filter 118 and/or the filter 189 (from the operation 210). The calculated difference may be stored by the processor 134 in the memory 136 as an absolute or raw delta pressure value obtained from the pressure sensor 128.

In an operation 214, the processor 134 may determine a sensor calibration offset for the pressure sensor 128 or other pressure sensors, e.g., another pressure sensor across the filter 189. In one aspect, the sensor calibration offset may be determined during a zero flow of the fuel from the fuel tank 108 to the engine 102. By way of example only and not by way of limitation, the pressure sensor 128 may be calibrated when the engine 102 has a zero speed (or, has been shut down), the oil temperature is greater than 30° C., a run time for the engine 102 is greater than 300 s, and the engine 102 has been shut down for a time period greater than 10 s.

In an operation 216, the sensor calibration offset is subtracted from the calculated difference of the operation 212 to determine a measured delta pressure (ΔPₘₑₐₛ). The value of the measured delta pressure (ΔPₘₑₐₛ) may be stored in the memory 136.

In an operation 218, the processor 134 may use a limiting circuit (not shown) to limit the measured delta pressure (ΔPₘₑₐₛ) to a range of values, for example, depending on the specific type of the filter 118. In one aspect, the operation 218 may be optional.

In an operation 220, the measured delta pressure (ΔPₘₑₐₛ) may be low pass filtered to remove noise and other undesired signal artifacts, e.g., sensor drift of the plurality of sensors 103 and/or other sensors providing signals to the ECM 104. For example, the processor 134 may send the measured delta pressure (ΔPₘₑₐₛ) data as a signal to the electronic filter 144 to smooth out the measured delta pressure (ΔPₘₑₐₛ) data received during or after the usage of the filter 118 and/or the filter 189. Alternatively, the operation 220 may be carried out prior to the processor 134 processing the data or signal received from the pressure sensor 128 and/or other sensors in the machine 100.

In an operation 222, the processor 134 may determine a scaled delta pressure (ΔP_{scaled}) according to equation (1):

$$Δ {P}_{scaled} = \frac{Δ {P}_{meas} - Δ {P}_{0}}{Δ {P}_{100} - Δ {P}_{0}} Δ {P}_{ref} \qquad ( 1 )$$

where ΔPₘₑₐₛ is the measured delta pressure, ΔP₀ is the delta pressure when the filter 118 and/or the filter 189 is new or 0% plugged (obtained from the operation 206), ΔP₁₀₀ is the delta pressure when the filter 118 and/or the filter 189 is fully plugged or 100% plugged (obtained from the operation 204), and ΔP_{ref} is a reference delta pressure 310 obtained from the plot 300 of the filter 118 and/or the filter 189. The processor 134 may perform a determination of the scaled delta pressure ΔP_{scaled} for a plurality of test data or actual field data related to the filter 118 and/or the filter 189. In equation (1), the measured delta pressure ΔPₘₑₐₛ is scaled into a range of known baseline with respect to ΔP₁₀₀, ΔP₀, and ΔP_{ref}. The reference delta pressure 310 (denoted by ΔP_{ref}) is a value calculated using a ΔP₁₀₀ value at a reference temperature and engine speed, and a ΔP₀ at the same reference temperature and engine speed. The reference delta pressure (ΔP_{ref}) 310 is calculated as follows using an equation (1.1):

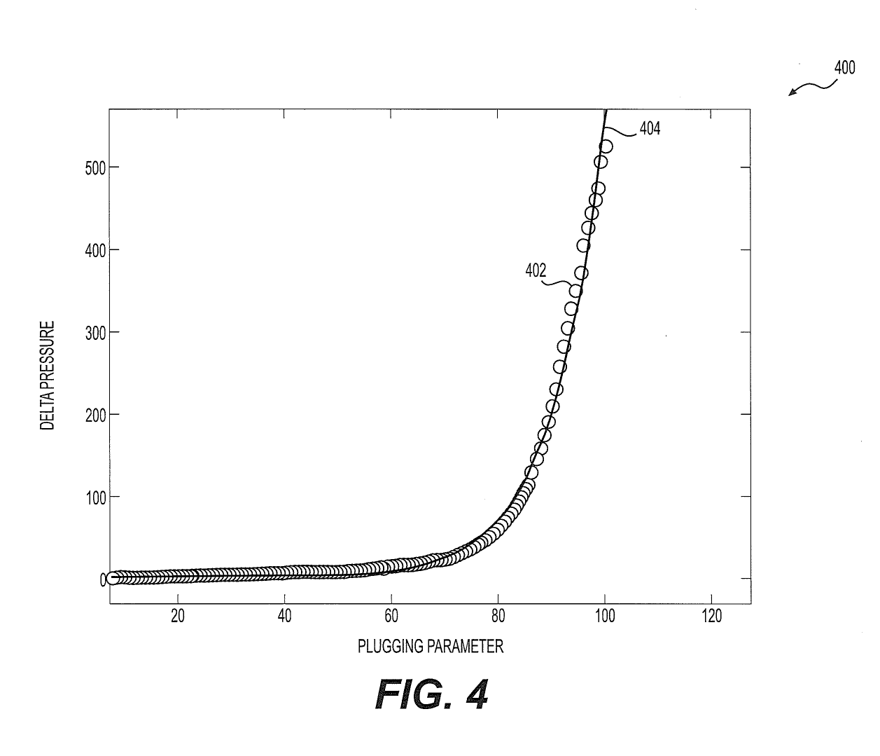

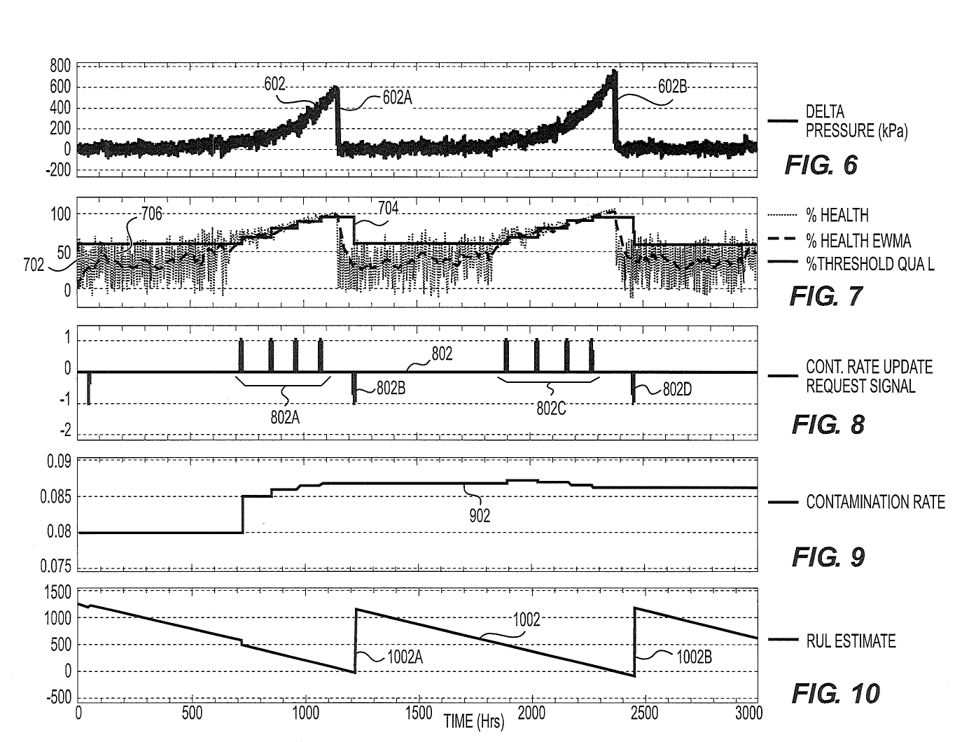

ΔP_{ref}=ΔP_{100,ref}−ΔP_{0,ref} (1.1)

where ΔP_{100,ref} is the delta pressure on a reference delta pressure map 304 at an engine temperature and speed (T_{ref}, ε_{ref}) for a fully plugged filter 118 and/or fully plugged filter 189, ΔP_{0,ref} is the delta pressure on the second delta pressure map 306 at T_{ref}, ω_{ref}. The reference delta pressure (ΔP_{ref}) 310 is a difference between a maximum value and the minimum value on a contamination profile of the filter 118 and/or the filter 189 defined by the reference delta pressure map 304 and the second delta pressure map 306, respectively. The contamination profile indicated by the reference delta pressure (ΔP_{ref}) 310 is a straight line on the plot 300 and uses same data as shown in FIG. 4, except that the plot 300 is logarithmic along the delta pressure axis, in accordance with an aspect of this disclosure. By way of example only and not by way of limitation, the scaled delta pressure ΔP_{scaled} obtained using the equations (1) and (1.1) may be displayed on the display 120 as a scaled delta pressure curve 602 illustrated in FIG. 6. The scaled delta pressure curve 602 illustrates transitions 602a and 602b indicating a sharp drop in the scaled delta pressure ΔP_{scaled} value. Such transitions 602a and 602b may occur when the filter 118 and/or the filter 189 is changed or cleaned and the scaled delta pressure ΔP_{scaled} drop across the filter 118 and the filter 189 is substantially equal to 0 kPa corresponding to when the filter 118 and/or the filter 189 is new. It will be appreciated that although FIG. 6 illustrates the scaled delta pressure curve 602, a similar curve may be displayed on the display 120 for the measured delta pressure ΔPₘₑₐₛ.

In an operation 224, the processor 134 provides an estimate of the health of the filter 118 and/or the filter 189. The health estimate of the filter 118 and/or the filter 189 may be based on the contamination profile obtained by the reference delta pressure map 304 at a given temperature and flow (or engine speed) obtained from laboratory testing of the filter 118 and/or the filter 189 (or, an equivalent or similar type of filter). By way of example only, the contamination profile of the filter 118 and/or the filter 189 may be determined using one or more procedures outlined in the International Standardization Organization (ISO) test “ISO 16889”, which describes a multi-pass filtration performance test with continuous contaminant injection for hydraulic fluid power filter elements, although other types of tests may be carried out on the filter 118 and/or the filter 189. Based upon the contamination or loading profile, a non-linear relationship between the scaled delta pressure ΔP_{scaled} and the plugging parameter (ε) may be established. For example, an exponential function according to equation (2) may be used to fit to the test data of the filter 118 and/or the filter 189 and the plugging parameter (ε) may be determined based upon such a non-linear relationship according to equation (2):

ΔP_{scaled}=αe^{βε} (2)

where α and β are fitted coefficients and e is the exponential function. It will be appreciated that the non-linear relationship between the plugging parameter (ε) and the scaled delta pressure ΔP_{scaled} is in addition to other types of non-linearities that may exist in the machine 100. For example, the engine speed and the oil temperature measurements by the speed sensor 124 and the temperature sensor 126, respectively, may include non-linear components too. However, the processor 134 takes into account the non-linear relationship between the plugging parameter (ε) and the scaled delta pressure ΔP_{scaled}, in addition to or as an alternative to the non-linearities in speed and temperature measurements, to more accurately get the health and the remaining useful life (RUL) estimate. Further, other types of non-linear relationships between the plugging parameter (ε) and the scaled delta pressure ΔP_{scaled} could be used by the processor 134. For example, parabolic, hyperbolic, trigonometric, or other types of non-linear curves could be used to determine a non-linear relationship between the plugging parameter (ε) and the scaled delta pressure ΔP_{scaled}. Accordingly, the fitted coefficients α and β may be determined by the processor 134 for different types of non-linear relationships between the plugging parameter (ε) and the scaled delta pressure ΔP_{scaled}.

Equation (2) may be modified by the processor 134 to yield equation (3) illustrating a logarithmic relationship between the plugging parameter ε and the scaled delta pressure ΔP_{scaled}:

$$ɛ = \frac{log ( Δ {P}_{scaled} ) - log ( α )}{β} \qquad ( 3 )$$

Using the equation (2) and/or the equation (3), the processor 134 may determine the plugging parameter (ε) for a given speed of the engine 102 and the oil temperature. A plurality of values 402 of the plugging parameter (ε) may be plotted in a plot 400 shown in FIG. 4. The processor 134 may fit an exponential curve 404 to the plurality of values 402 to estimate the plugging parameter (ε) of the filter 118 and/or the filter 189 exponentially related to the scaled delta pressure ΔP_{scaled}. As illustrated in FIG. 4, by way of example only and not by way of limitation, α=0.02 and β=0.102, although other values of the fitted coefficients α and β could be used. It will be appreciated that the plugging parameter (ε) may be expressed as a percentage and be referred to herein as a percentage plugged value used as an indicator of an amount of plugging of the filter 118 and/or the filter 189, though other parameters could be used to indicate the plugging or contamination of the filter 118 and/or the filter 189. For example, the plugging parameter (ε) may be expressed as a normalized value lying between 0 to 1, as an absolute value (e.g., in parts per million or ppm), and the like, or combinations thereof.

In an operation 226, the processor 134 may apply a moving average to the plugging parameter (ε) value calculated in the operation 224. The moving average may be determined by the processor 134 by exponentially weighing the past and current data associated with the filter 118 and/or the filter 189. Recent data are multiplied by values close to 0.99 while past data are multiplied by values close to 0.001 effectively canceling the contribution of distant passed/processed values in the moving average, although other weighting coefficients based upon a type of the filter 118 and/or the filter 189 could be used.

In an operation 228, the processor 134 may determine a health estimate of the filter 118 and/or the filter 189 based upon the plugging parameter (ε). In one aspect, the health estimate of the filter 118 and/or the filter 189 may be determined by the processor 134 as belonging to or falling in one of the plurality of threshold ranges 502, 504, 506, 508, 510, and 512 shown in a plot 500 in FIG. 5. By way of example only, the threshold ranges 502, 504, 506, 508, 510, and 512 put the plugging parameter (ε) into bins corresponding to, for example, 0-60%, 60-75%, 75-85%, 85-90%, 90-95%, and 95-100% plugged, respectively. Such binning of the percentage plugged (ε) value of the plugging parameter to estimate the health of the filter 118 and/or the filter 189 removes noise in the calculations carried out by the processor 134. The processor 134 may apply a moving rolling range qualifier algorithm to determine which bin the plugging parameter (ε) falls into with respect to the specified threshold ranges 502, 504, 506, 508, 510, and 512 in FIG. 5. By way of example only and not by way of limitation, values 514a, 514b, and 514c of the plugging parameter (ε) fall above the threshold ranges 504, 506, and 508, respectively, taking into account confidence bands determined by curves 520 and 530 and a mean curve 540. After the values 514a, 514b, and 514c of the plugging parameter (ε), expressed in FIG. 5 as a percentage health estimate, fall above a current threshold range (e.g., the threshold ranges 504, 506, and 508, respectively), the health estimate will latch to the next bin and the threshold range will increase, for example, to the threshold range 506, 508, and 510, respectively for the values 514a, 514b, and 514c. In one aspect, after the filter 118 and/or the filter 189 has been changed, the health estimate should move below the lowest threshold range, i.e., the threshold range 502. Likewise, after a specified percent of health estimates fall below the lowest threshold range 502, the health estimate and threshold may be reset by the processor 134 to a lower bound, i.e., a lower bond of the threshold range 502. It will be appreciated that the number of threshold ranges 502, 504, 506, 508, 510, and 512 is by way of example only and not by way of limitation. As such, any number of threshold ranges and bins could be used depending on a resolution of the plurality of sensors 103 and the processor 134. As illustrated in FIG. 7, the health estimate may be displayed on the display 120 and stored in the memory 136 continuously as a plot 706 with respect to a threshold plot 704 and a moving average plot 702 by the processor 134.

In an operation 230, a total filter hours of the filter 118 and/or the filter 189 may be obtained by the processor 134. The total filter hours may be stored in the memory 136 of the ECM 104 based upon a difference of a time between a total time the machine 100 has been operating and a time when the filter 118 and/or the filter 189 was newly installed or was changed. For example, the processor 134 may obtain a usage time of the filter 118 and/or the filter 189 (e.g., in hours) from the memory 136. The total filter hours may be changed or reset by a technician every time the filter 118 and/or the filter 189 is changed or cleaned. By way of example only, the ECM 104 may include an internal clock configured to provide a timestamp of a new installation of the filter 118 and/or the filter 189 to the processor 134.

In an operation 232, the processor 134 may determine or estimate a contamination rate of the filter 118 and/or the filter 189. In one aspect, the contamination rate estimate may be determined by the processor 134 when a threshold range (e.g., one or more of the threshold ranges 502, 504, 506, 508, 510, and 512) of the health estimate of the filter 118 and/or the filter 189 is crossed. Such crossings of the threshold ranges 502, 504, 506, 508, 510, and 512 may be latched or stored in the memory 136. By way of example only and not by way of limitation, the contamination rate estimate may be determined by the processor 134 using a recursive least squares (RLS) algorithm, although other types of estimation algorithms including but not limited to a Least Mean Squares Filter, Kalman Filter, Particle Filter, Weiner Filter, etc., could be used. As part of the RLS algorithm, the processor 134 may obtain previously saved values of the contamination rate estimate from the memory 136, a new health estimate (resulting from the operation 228), and a current timestamp for usage time of the filter 118 and/or the filter 189 (from the operation 230) to estimate a new contamination rate estimate. The contamination rate estimate may be displayed on the display 120 as a function of time using a plot 900 showing a contamination rate estimate 902 in FIG. 9. The processor 134 may begin a determination of the contamination rate of the filter 118 by receiving a contamination rate update request signal 802 from a rolling range qualifier process (in the operation 228), identifying that the plugging parameter is in a new bin of the threshold ranges 502, 504, 506, 508, 510, and 512, and has been in that new bin for a certain time, as illustrated in FIG. 8. The contamination rate update request signal 802 may include a series of pulses 802a and 802b separated by pulses 802b and 802d, for example. When the contamination rate update request signal 802 is equal to zero, the processor 134 may not take any action and may use and maintain a previous value of the contamination rate in the memory 136. Upon receiving one or more of the series of pulses 802a, each being equal to 1, the processor 134 may calculate a current contamination rate. The processor 134 may then perform a calculation based on equations (4), (4.1), and (5):

Y=ε (4)

θₒ=\dot{ε} (4.1)

x=t (5)

where ε is the plugging parameter obtained from equation (3), ‘Y’ is a first variable in the memory 136, ‘t’ is the current timestamp obtained from the operation 230, ‘x’ is a second variable in the memory 136, where θₒ is a current value of the contamination rate stored in the memory 136 denoted as \dot{ε} in equation (4.1). The pulses 802b and 802d may indicate to the processor 134 to update the contamination rate \dot{ε} stored in the memory 136. Further, the pulses 802b and 802d identify to the processor 134 that the filter 118 and/or the filter 189 are to be newly installed.

The processor 134 may then calculate a covariance matrix P based upon an equation (6):

$$P = \frac{1}{FF} ( {P}_{0} - \frac{{P}_{0} {xx}^{′} {P}_{0}}{FF + {x}^{′} {P}_{0} x} ) \qquad ( 6 )$$

where ‘FF’ is referred to as a forgetting factor typically set at 0.99, 0.95, or 0.90 depending on the desired width of time window to be used to calculate the average, P₀ is a previous covariance matrix stored in the memory 136, x′ is a regressor vector or matrix, and x′ represents a transpose of the regressor vector x.

The processor 134 may calculate an error matrix e according to an equation (7). To calculate a value of the error matrix e, we use the current estimate of the percent plugged Y=ε from equation (4), the stored estimate of the contamination rate, θ and the timestamp x=t in the equation (7):

e=Y−θₒ^{T}x (7)

where θₒ is a current value (in matrix/vector form) of the contamination rate stored in the memory 136 and obtained by the processor 134 upon receipt of the contamination rate update request signal 802. Based upon the calculation of the error matrix e, the processor 134 determines a current value θ of the contamination rate using an equation (8), where e′ is a transpose of the error matrix e:

$$θ = {θ}_{0} + \frac{{P}_{0} x {e}^{′}}{FF + {x}^{′} {P}_{0} x} \qquad ( 8 )$$

The processor 134 may then update the memory 136 regarding the new values of θ and the covariance matrix P and save the new values of θ and the covariance matrix P in the memory 136. Alternatively or additionally, the new values of θ and the covariance matrix-P may be provided (e.g., wirelessly) by the processor 134 to a base station (not shown) remote to the machine 100 for analysis, control, and/or monitoring while the machine 100 is in use.

In an operation 234, the processor 134 may determine the remaining useful life (RUL) of the filter 118 using an equation (9):

$$RUL = \frac{EOL}{θ} - ( T - {t}^{′} ) \qquad ( 9 )$$

where EOL is an acronym for an end of life parameter, e.g., set to 100, for a fully plugged filter, T is the total operating hours of the machine 100, t′ is a time since the filter 118 and/or the filter 189 was last changed, and RUL is an acronym for remaining useful life. For example, when the plugging parameter c is expressed as a percent plugged value to estimate the contamination rate and the remaining useful life, the percent plugged is within a range of 0% to 100%, with 100% representing a fully plugged state of the filter 118 and/or the filter 189. The contamination rate estimate is measured in percentage (%) per hour, in which the filter 118 and/or the filter 189 is being plugged. By dividing percentage (EOL) by percentage per hour (%/Hr.), equation (9) yields a total number of hours (or, RUL) that the filter 118 and/or the filter 189 could survive if plugging is continued at the current rate. For example, if EOL=100% and 0=0.08%/Hr., then RUL=100/0.08=1250 Hours. In one aspect of this disclosure, equation (9) may be modified to equation (10) as follows:

$$RUL = \frac{EOL}{θ} - t \qquad ( 10 )$$

where t=total filter hours as obtained in the operation 230. The remaining useful life of the filter 118 and/or the filter 189 may then be determined as RUL=1250−T for a value of θ=0.08 %/Hr. The RUL estimate from equations (9) and (10) may be determined in units of time (e.g., minutes, hours, days, etc.). Generally, one or more of the equations (1)-(10) may be matrix equations, although calculations may be carried out by the processor 134 using one or more scalar values from the equations (1)-(10).

In an operation 236, the RUL estimate calculated from the equations (9) and/or (10) may be provided or outputted to the display 120 or to other output devices (not shown). By way of example only and not by way of limitation, the display 120 may be controlled by the processor 134 to display an RUL estimate curve 1002 illustrated in FIG. 10. As illustrated, the RUL estimate curve 1002 may be displayed or outputted on the display 120 to indicate jumps 1002a and 1002b when the filter 118 and/or the filter 189 was changed or cleaned. Although the RUL estimate curve 1002 is displayed as a periodic linear curve in FIG. 10, such linearity is by way of example only and not by way of limitation, as for specific types of the filter 118, the RUL estimate curve 1002 may be non-linear, non-periodic, and the like, or combinations thereof. Further, every time the filter 118 and/or the filter 189 is changed, the RUL estimate curve 1002 shows jumps 1002a indicating that the new filter 118 and/or the new filter 189 has a higher or increased remaining useful life, which keeps falling as time of usage of the filter 118 and/or the filter 189 progresses. Based upon the RUL estimate curve 1002, an operator or a technician can obtain information about when to change or replace the filter 118 and/or the filter 189 with a new filter, based on a real-time condition of the filter 118 and/or the filter 189. Such real-time condition based maintenance of the filter 118 and/or the filter 189 reduces the unnecessary replacement of the filter 118 and saves overhead and operational costs for an owner or user of the machine 100. Further in the operation 236, the processor 134 may store the remaining useful life of the filter 118 and/or the filter 189 in the memory 136 of the machine 100 (e.g., from the data used to generate the RUL estimate curve 1002).

In an operation 238, the processor 134 may control a flow of a fluid (oil or hydraulic fluid) entering the filter 118 and/or the filter 189. The processor 134 may carry out such controlling based on the plugging parameter (ε), for example, when the plugging parameter (ε) falls within a threshold range or above a threshold range (e.g., one of the plurality of threshold ranges 502-512) during usage of the machine 100. In one aspect, as part of the controlling of the fluid entering the filter 118 and/or the filter 189, the processor 134 may send a signal (electrical, wireless, acoustic, and/or optical) to the switch 152 and/or the switch 192 for preventing the fluid from entering the filter 118 and/or the filter 189. Further, the processor 134 may send another signal (electrical, wireless, acoustic, and/or optical) to cutoff or disconnect the filter 118 and/or the filter 189. Therefore, fuel may directly enter the engine 102 or the plurality of injectors 106 (when the filter 118 is cutoff), and hydraulic fuel may directly enter the hydraulic system 188 (when the filter 189 is cutoff). The operation 134 may be carried out in parallel with the operation 236 and at any point during operation of the machine 100, based upon a determination of the plugging parameter (ε) and/or the RUL of the filter 118 and/or the filter 189. In one aspect, the method 200 may be carried out automatically, without human intervention, by the processor 134. For example, the processor 134 may, in real-time, while the machine 100 is being used, and/or the filer 118 and/or the filter 189 is being used, carry out the operation 238 controlling and/or preventing the flow of the fluid to the filter 118 and/or the filter 189 when different conditions are met (e.g., current values of the plugging parameter (ε) and/or the RUL estimate being above a threshold value in the plurality of threshold ranges 502-512).

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Additionally, the various aspects of the disclosure with respect to the system 101 may be implemented in a non-generic computer implementation. Moreover, the various aspects of the disclosure set forth herein improve the functioning of the system 101 as is apparent from the disclosure hereof. Furthermore, the various aspects of the disclosure involve computer hardware that is specifically programmed to solve the complex problem addressed by the disclosure. Accordingly, the various aspects of the disclosure improve the functioning of the machine 100 overall and the system 101 in its specific implementation to perform the processes set forth by the disclosure and as defined by the claims.

We claim:

1. A method for estimating a remaining useful life of a filter, comprising:
determining, at a processor of a machine, a scaled delta pressure of the filter in the machine based on an input from a plurality of sensors;
determining, at the processor, a plugging parameter of the filter based upon a non-linear relationship between the scaled delta pressure and the plugging parameter of the filter;
controlling, using a signal from the processor to a switch, a flow of a fluid entering the filter based upon the plugging parameter while the machine is used;
estimating, at the processor, the remaining useful life of the filter at a time instant based upon a contamination rate estimate, the contamination rate estimate being determined based upon the determined plugging parameter; and
outputting, from the processor, the estimated remaining useful life of the filter on a display while the machine is used.

2. The method of claim 1 further comprising:
receiving, at the processor, a first delta pressure map corresponding to the filter being fully plugged and a second delta pressure map corresponding to the filter being new, wherein the scaled delta pressure of the filter is based upon the first delta pressure map, the second delta pressure map, and a reference delta pressure map.

3. The method of claim 2, wherein the reference delta pressure map is based upon an engine speed and an oil temperature obtained from a speed sensor and a temperature sensor, respectively, during a usage of the filter.

4. The method of claim 2, wherein the scaled delta pressure is further based upon a sensor calibration offset of the plurality of sensors.

5. The method of claim 2, wherein the first delta pressure map, the second delta pressure map, and the reference delta pressure map are associated with a specific type of the filter.

6. The method of claim 1 further comprising:
determining, at the processor, a health estimate of the filter based upon the plugging parameter, the plugging parameter being expressed as a percentage plugged value of the filter, the health estimate being determined as one of a plurality of threshold ranges of the plugging parameter.

7. The method of claim 1, wherein the contamination rate estimate is determined based on a recursive least squares algorithm, the contamination rate estimate being determined by the processor when a threshold range of the plugging parameter of the filter is crossed.

8. The method of claim 1, wherein the estimating the remaining useful life of the filter is further based upon a time since the filter was changed, and wherein the non-linear relationship is an exponential or a logarithmic relationship between the scaled delta pressure and the plugging parameter of the filter.

9. The method of claim 1 further comprising:
displaying, at the display controlled by the processor, a continuous estimate of the remaining useful life of the filter, said displaying being used for identifying when the filter was installed in the machine and when the filter is to be replaced with a new filter.

10. A system for estimating a remaining useful life of a filter, the system comprising:
an electronic control module coupled to a display, the electronic control module including a processor and a memory, the processor operatively coupled to a plurality of sensors and configured to:
determine a scaled delta pressure of the filter based on an input from the plurality of sensors;
determine a plugging parameter of the filter based upon a non-linear relationship between the scaled delta pressure and the plugging parameter of the filter;
estimate the remaining useful life of the filter at a time instant based upon a contamination rate estimate, the contamination rate estimate being determined based upon the determined plugging parameter; and
output the remaining useful life of the filter on the display while the filter is being used.

11. The system of claim 10, wherein the processor is further configured to:
receive a first delta pressure map corresponding to the filter being fully plugged and a second delta pressure map corresponding to the filter being new, wherein the scaled delta pressure of the filter is based upon the first delta pressure map, the second delta pressure map, and a reference delta pressure map; and
prevent a fluid from entering the filter when the plugging parameter falls above a threshold range.

12. The system of claim 11, wherein the reference delta pressure map is based upon an engine speed and an oil temperature obtained from a speed sensor and a temperature sensor, respectively.

13. The system of claim 11, wherein the scaled delta pressure is further based upon a sensor calibration offset of the plurality of sensors.

14. The system of claim 11, wherein the first delta pressure map, the second delta pressure map, and the reference delta pressure map are associated with a specific type of the filter.

15. The system of claim 10, wherein the processor is further configured to:
determine a health estimate of the filter based upon the plugging parameter, the health estimate being determined as one of a plurality of threshold ranges.

16. The system of claim 10, wherein the processor is further configured to determine the contamination rate estimate based on a recursive least squares algorithm, the contamination rate estimate being determined by the processor when a threshold range of a health estimate of the filter is crossed.

17. The system of claim 10, wherein the processor is configured to estimate the remaining useful life of the filter further based upon a time since the filter was changed, and wherein the non-linear relationship is an exponential or a logarithmic relationship between the scaled delta pressure and the plugging parameter of the filter.

18. The system of claim 10, wherein the processor is further configured to:
control the display configured to output a continuous estimate of the remaining useful life of the filter for identifying when the filter was installed in a machine and when the filter is to be replaced with a new filter.

19. A machine comprising the system of claim 10.

20. A non-transitory computer readable medium storing computer executable instructions thereupon for estimating a remaining useful life of a filter in a machine, the instructions when executed by a processor of an electronic control module of the machine cause the processor to:
determine a scaled delta pressure of the filter based on an input from a plurality of sensors;
determine a plugging parameter of the filter based upon a non-linear relationship between the scaled delta pressure and the plugging parameter of the filter;
control, using a signal from the processor to a switch, a flow of a fluid entering the filter based on the plugging parameter while the machine is used;
estimate the remaining useful life of the filter at a time instant based upon a contamination rate estimate, the contamination rate estimate being determined based upon the determined plugging parameter; and
output the remaining useful life of the filter on a display coupled to the electronic control module.
